(19) United States
(12) Patent Application Publication
(10) Pub. No.: US 2012/0085375 A1
(43) Pub. Date: Apr. 12, 2012

(54) Unique hopper cleaning unit

(76) Inventor: Harold Weldon Laukka, Westland, MI (US)

(21) Appl. No.: 12/927,553

(22) Filed: Jul. 18, 2011

Related U.S. Application Data
(60) Provisional application No. 61/402,376, filed on Aug. 30, 2010.

(51) Int. Cl. B08B 9/08

(52) U.S. Cl. 134/166 R

(57) ABSTRACT

This unit will revolutionize the way hoppers are cleaned. It is no longer necessary to disassemble the hopper to clean the gears. Water pressure through a small tube is used to force filling out of all areas of the gear box. Current methods of cleaning the hopper requires complete dis-assembly of the hopper. During re-assembly extreme care must be taken to prevent damage to the seal or the base. Damage of either one renders the hopper inoperative. The Unique Hopper Cleaning unit reduces time, and thoroughly and efficiently cleans the hopper. No maintenance, easy to store.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

While helping out at a family owned donut shop, I was assigned to cleaning hoppers. The method of cleaning was to disassemble the hopper base, clean the hopper gears then re-assemble. Disassembly was easy. Re-assembly was difficult. Care had to be taken to not break the tubular seal or crack the plastic base when tightening the bolts. Replacing the tubular seal was difficult because after removing it from the hopper the seal became too long to fit back into the groove. After some time I managed to insert the seal. (Later I learned that the tubular seal was placed into the freezer to shrink it back to size allowing it to be fit into the groove.) Tightening the bolts to the base had to be done with care because mounting holes are easily broken. See picture of broken mounting tab. Page 8, picture #1. Once a tab is broken the hopper is inoperative because the filling leaks through the area not tightened with a bolt. That was the first and last time I cleaned a hopper by dissembling it.

Many companies do not clean their hoppers for months because of the cumbersome, inefficient cleaning process. There had to be a better way. I had the idea to force water pressure against the gears. It worked. Now cleaning a hopper was easy, fast and convenient. No longer was it necessary to remove the base.

This Unique Hopper Cleaning Unit is a must for the donut and pastry industry. This is for the health and welfare of the General Public. Cleaning takes about 10 minutes at most, compared to 30 minutes to one hour. Time and money are saved. There is no other unit like this. There are those who will improvise on this unit by attaching a hose in some manner to a faucet. This is infringement on my idea.

### BRIEF SUMMARY OF THE INVENTION

Cleaning hoppers has always been a hassle, inefficient and time consuming. The Unique Hopper Cleaning Unit reduces cleaning time, is efficient and cleans the whole unit including the gears, and small holes and crevices. See page 9, picture #2. Simply attach the Unique Hopper Cleaning Unit to the faucet, put the plastic tube into the hole at the front of the hopper, then slowly turn on the hot water until the gears are turning. The flow of water will force the residual filling out the front of the hopper through the small holes. See page 9, picture #2. In minutes the hopper is clean, no residual filling left in the gears. This Unique Hopper Cleaning Unit is a must for the donut and pastry industry. This is for the health and welfare of the General Public. This unit will revolutionize the cleaning of hoppers. There is no longer an excuse for not cleaning hoppers on a daily basis.

### BRIEF DESCRIPTION OF THE SEVERAL VIEWS OF THE DRAWING

Not Applicable

### DETAILED DESCRIPTION OF THE INVENTION

The Unique Hopper Cleaning Unit is made up of 5 pieces that when assembled together create a unique cleaning system. See page 15, picture #8.

Making Unit:
1. Adapter Quick Connect/Disconnect assembly: Adapter threads to most conventional faucets. Locktite adhesive is applied to the threads of the assembly as a sealer, preventing loosening of the connection. (see page10, picture #3)
2. Reducer: Connects to the Adapter Quick connect/disconnect assembly. Reduces the opening from ¾″ to 3/16″. (see page 11, picture #4)
3. Hose Barb: Attaches to the Reducer. Locktite adhesive is applied to the threads as a sealer, preventing loosening of the connection. (see page 12, picture #5)
4. Plastic tube: Is attached to Hose Barb with a clamp. (see page 13, picture #6)
5. Clamp: Is used to hold Plastic tube to Hose Barb. (see page 14, picture #7)

Process of Assembly:
1. The units are assembled in the order as listed above. Locktite is applied to the Adapter Quick Connect/Disconnect assembly threads. The Reducer is attached to Adapter Quick Connect/Disconnect assembly and tightened with appropriate sized wrench. Locktite is applied to the Hose Barb which is then attached to the Reducer. Plastic tube is attached to the Hose Barb and clamped in place.

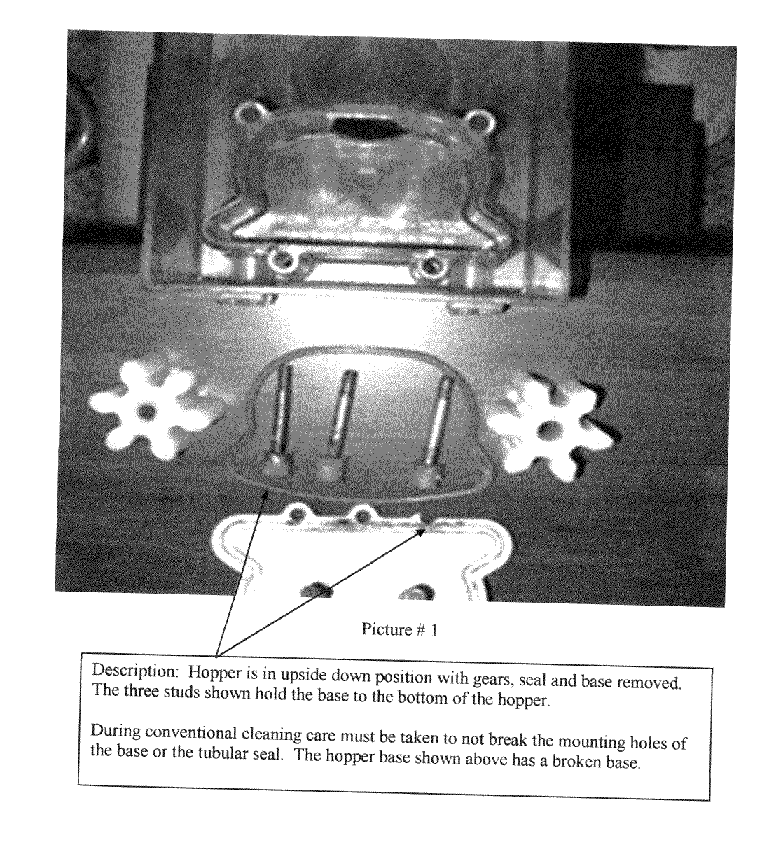

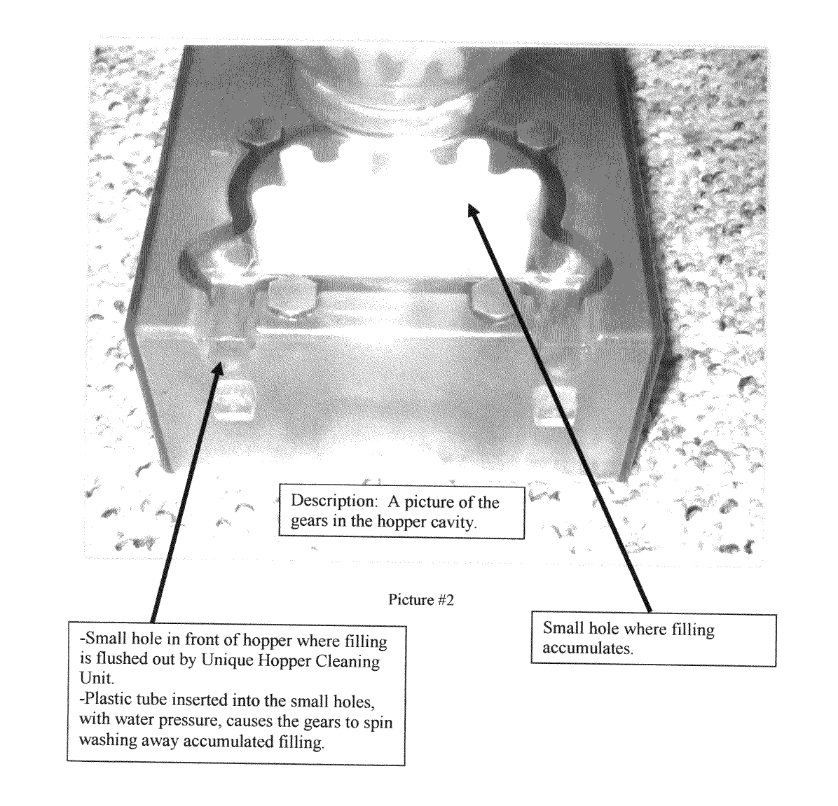

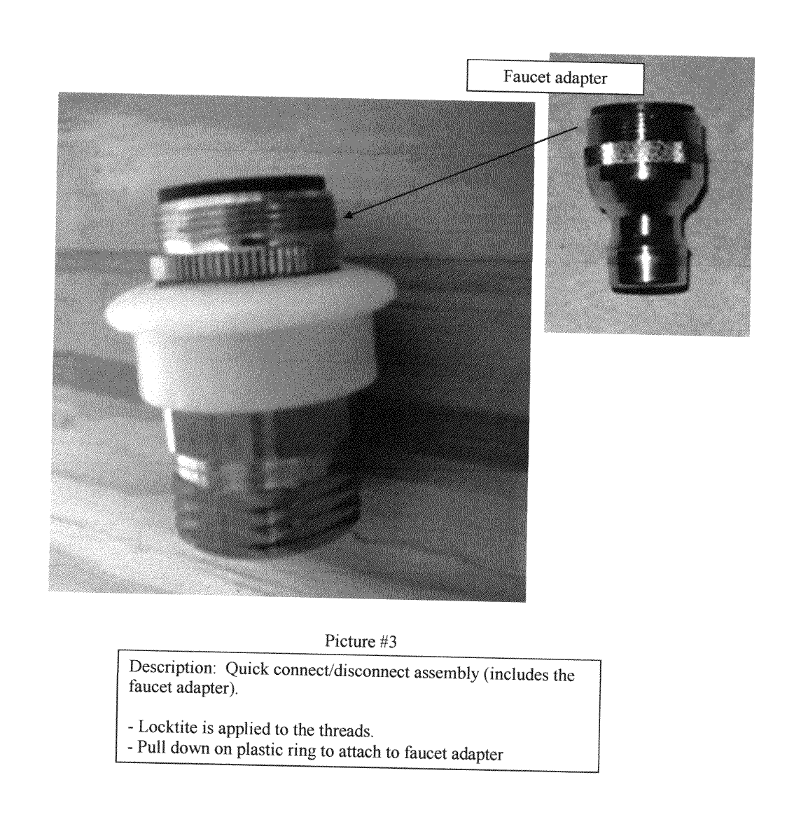

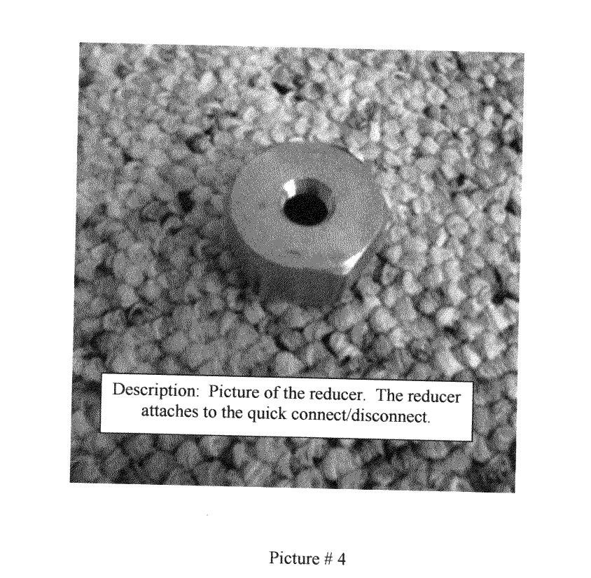

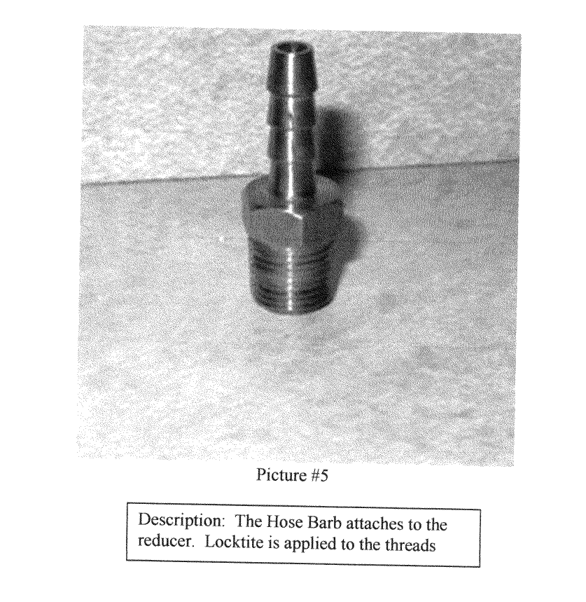

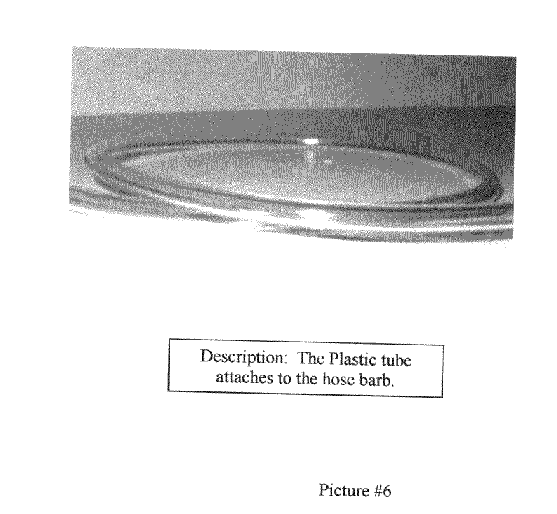

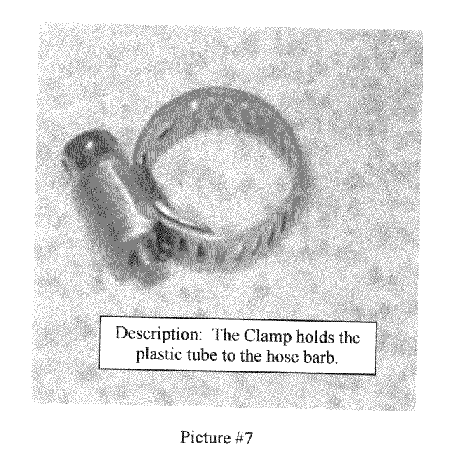

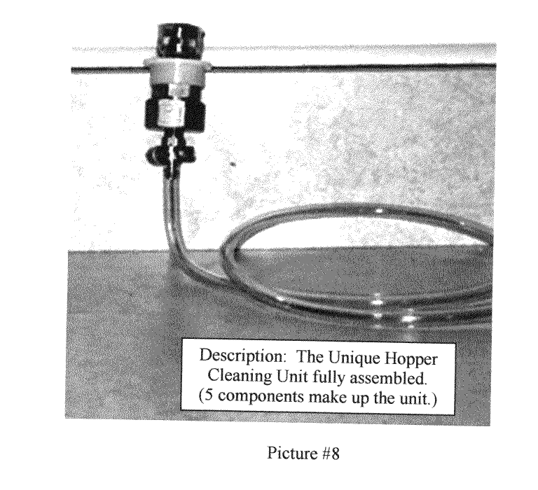

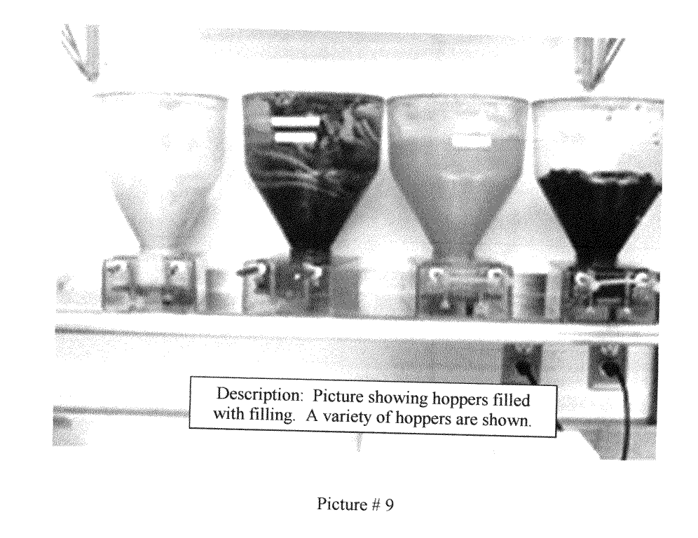

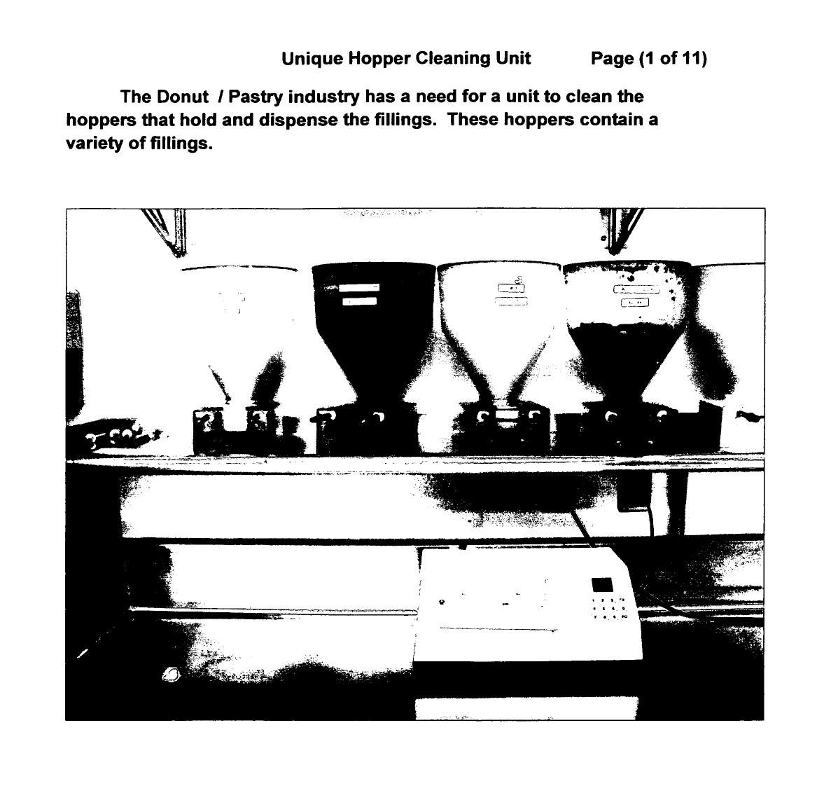

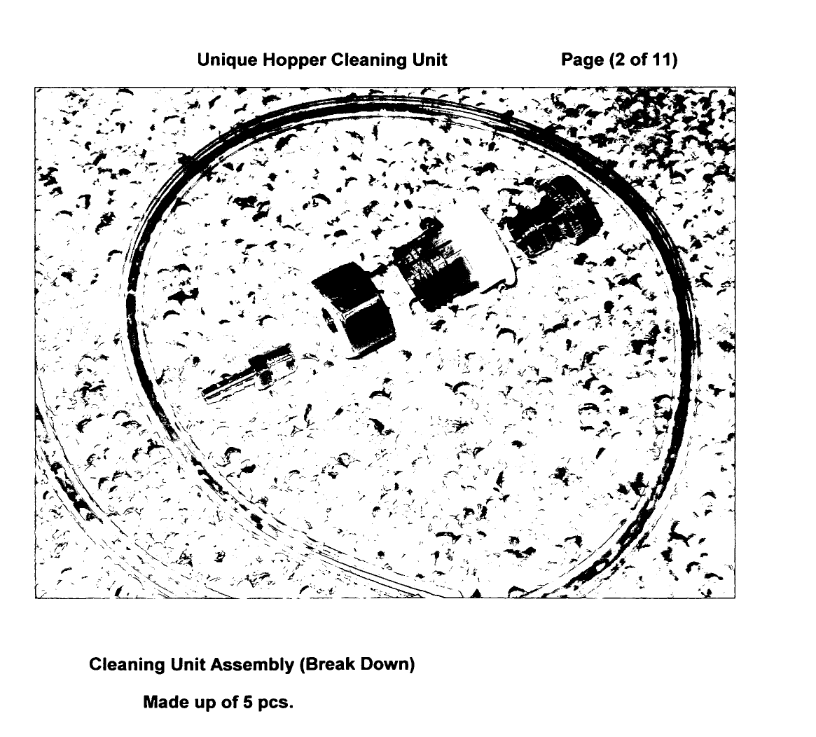

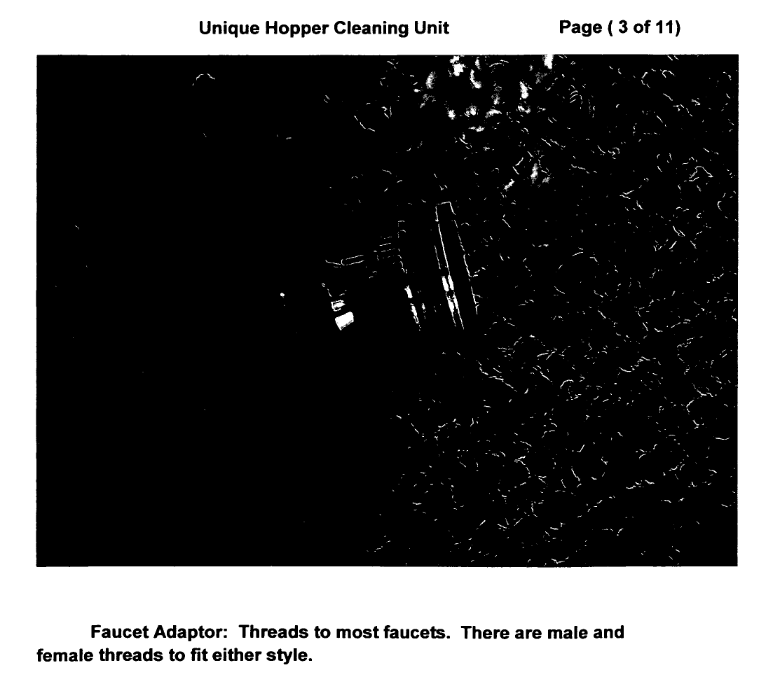

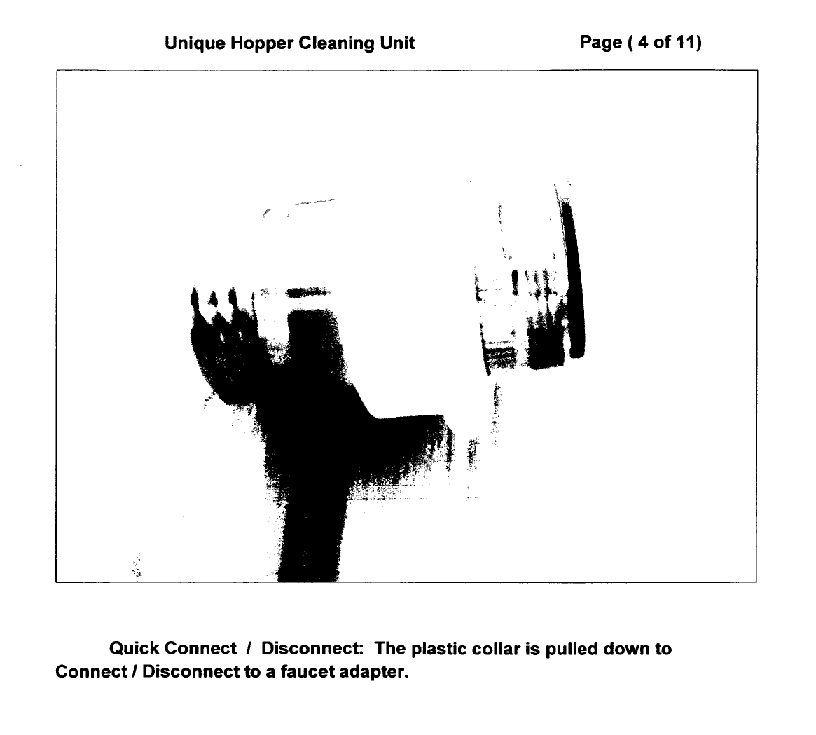

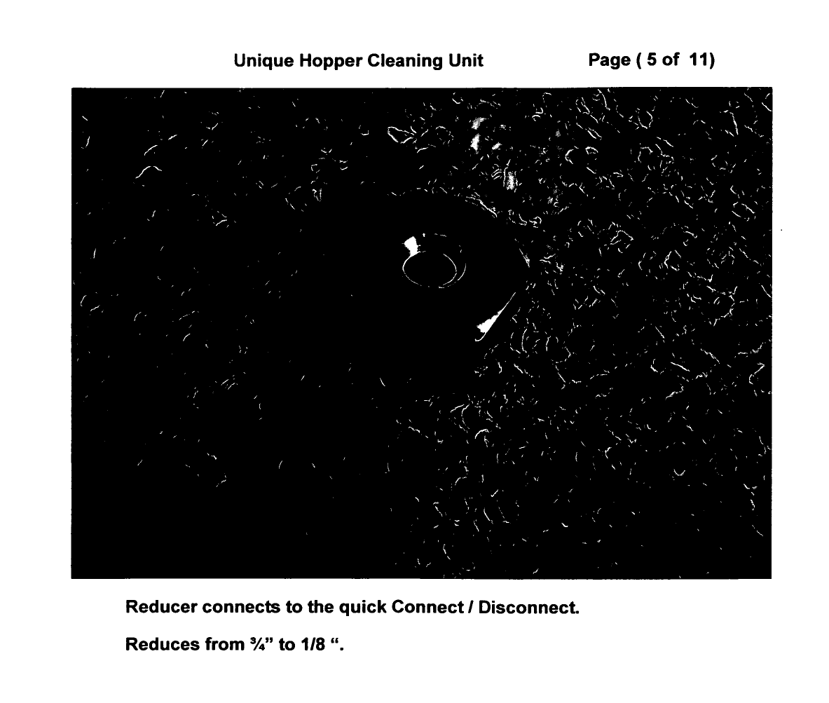

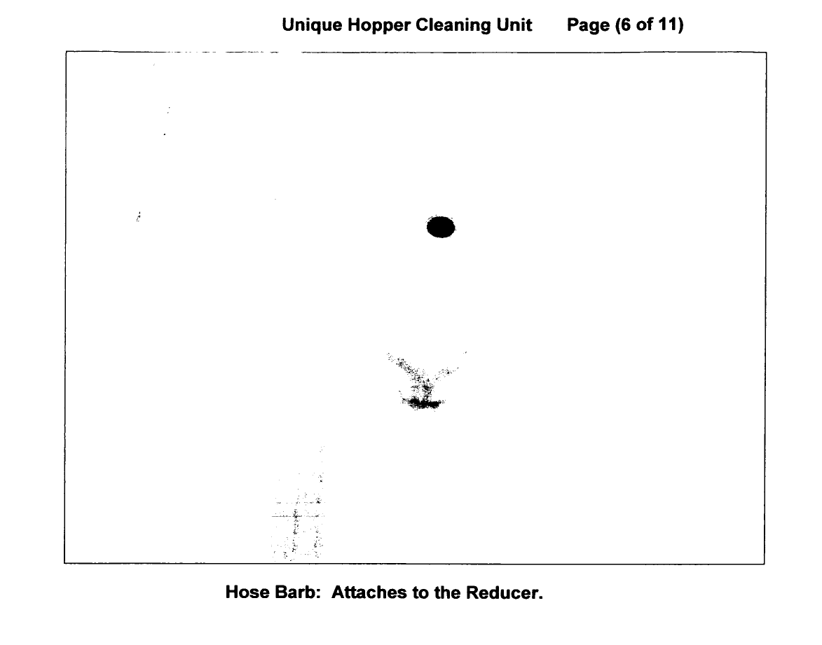

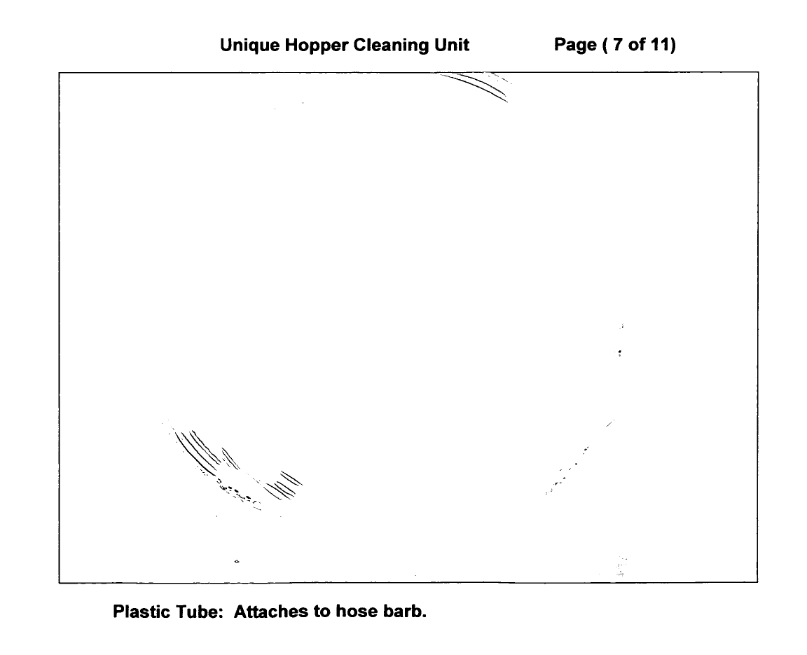

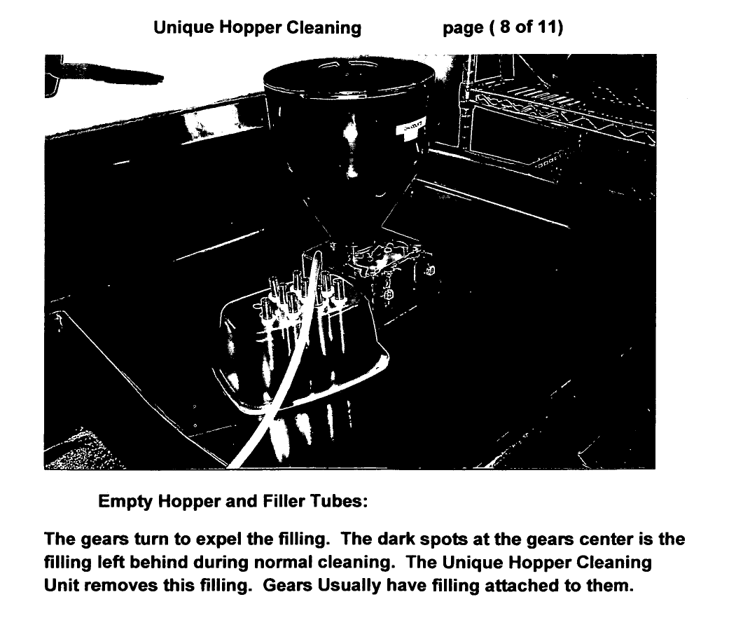

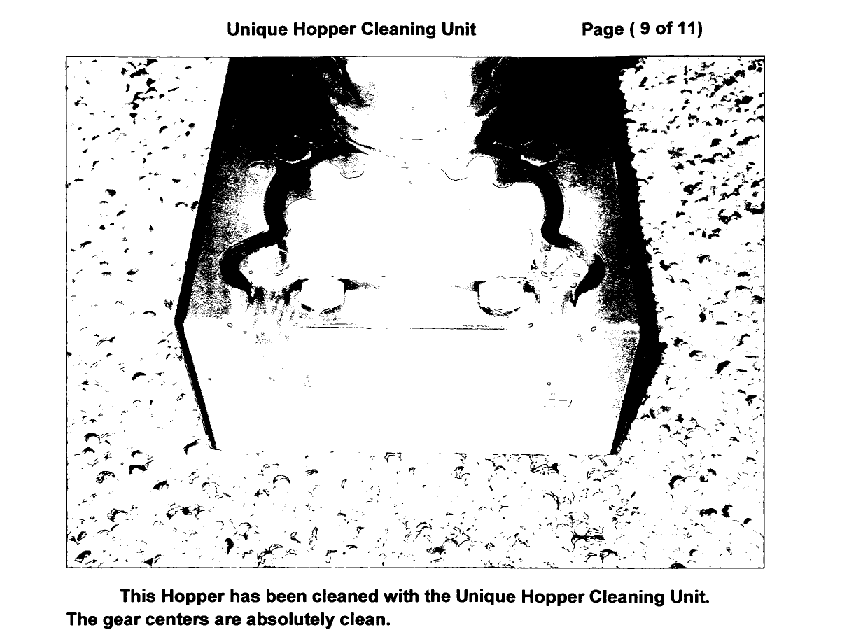

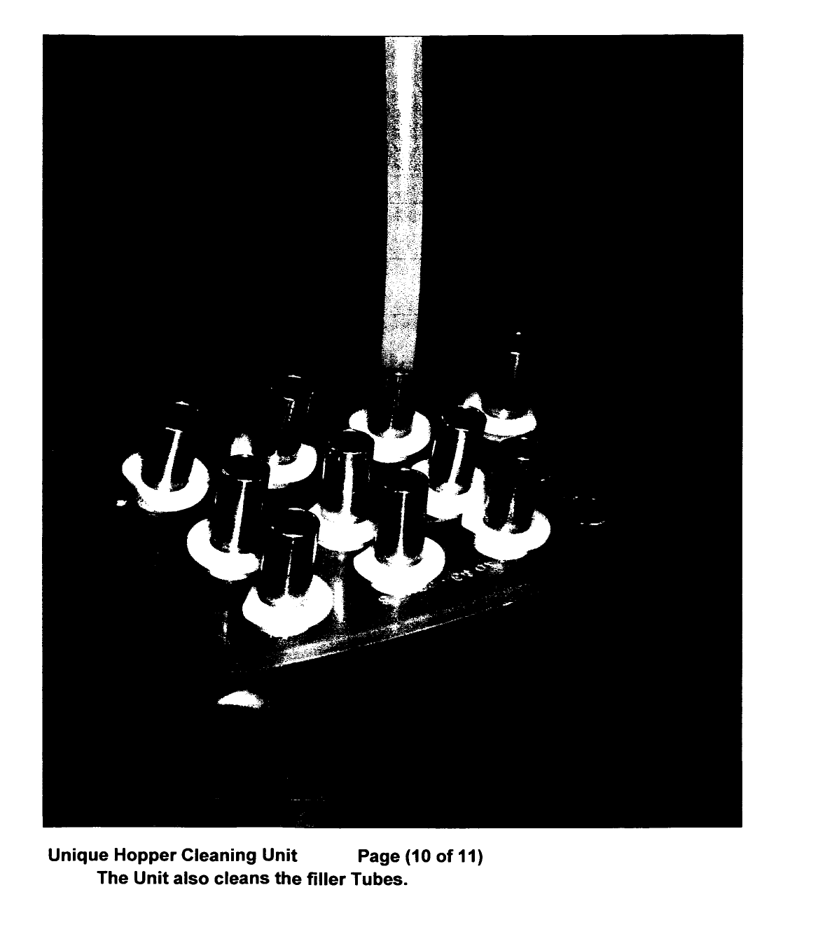

Using Unit:
1. Remove the aerator from the faucet.
2. Remove the faucet adapter from the Unique Hopper Cleaning Unit. (see page 10, picture #3)
3. Attach the faucet adapter to the faucet.
4. Attach quick connect/disconnect to the faucet by pulling down the plastic ring which causes it to snap into place on the faucet adapter. (see page 10, picture #3)
5. Unique Hopper Cleaning Unit is ready to use.
6. Have hopper in sink ready to be cleaned.
7. Insert plastic tube into large opening of the hopper, all the way down to the bottom of the hopper, near the gears.
8. Slowly turn on water until desired water pressure is achieved.
9. Water pressure will force water into the gear area and out of the small holes in the front of the hopper. (see page 9, picture #2)
10. Turn off the water. Insert the plastic tube into the small holes in the front of the hopper and slowly turn water on again until desired water pressure is reached. Water is forced into the gears causing them to spin rapidly. (see page 9, picture #2)
11. The turning of the gears and the force of the water expels all trapped filling from the hopper gears. The hopper is now clean!
[Page 1] [FIG. 1] This picture shows Edhard hoppers that the Unique Hopper Cleaning Unit will clean.
[Page 2] [FIG. 2] This picture show the assembly of the Unique Hopper Cleaning Unit which is made up of several parts which consists of brass and plastic.
[Page 3] [FIG. 3] The faucet adapter is a machined part which is chrome plated and includes standard pipe threads.
[Page 4] [FIG. 4] The quick connect/disconnect assembly is brass with a plastic ring which holds the bearings. The bearings create a connecting lock.
[Page 5] [FIG. 5] The reducer (¾″-⅛″) is machined brass, made from a hexagon brass bar. Threads of ¾″ and ⅛″ are added.
[Page 6] [FIG. 6] The hose barb is made from a brass hexagon bar with ⅛″ pipe threads added.
[Page 7] [FIG. 7] The plastic tubing is vinyl. 3/16″ I.D- 5/16″ O.D.
[Page 8] [FIG. 8] For reference. Illustration shows empty Hopper. Filler tubes are shown in a holding case, for easy cleaning and drying.
[Page 9] [FIG. 9] For reference. Illustration shows hopper gears that have been cleaned.
[Page 10] [FIG. 10] For reference. Illustration shows the Unique Hopper Cleaning Unit plastic tube inserted into filler tube for easy cleaning.

Unique Hopper Cleaning Unit Page (1 Of 1)
The problem is attempting to clean the filling attached to the gears. Following are the instructions to use the Unique Hopper Cleaning Unit. Connecting the Hopper Cleaning Unit to a Hot Water faucet is the first step. Using the connect/disconnect feature makes it simple. Step Two—Insert the hose into one of the holes leading to the gears. Step Three—Turn on the Hot water faucet to get a stream of high Volume Water. The water flowing against the gears causes the gears to spin at a very high revolution. The force of the water and the high revolution expels the filling. The turmoil of the Hot Water also cleans the holes of the gear shafts.
The Following illustrations show the makeup of the Unique Hopper Cleaning Unit.

Unique Hopper Cleaning Unit Page (11 of 11)

Cleaning Hoppers has always been a problem. It is time consuming and inefficient. Most of the time some filling is left attached to the gears. This cleaning unit reduces cleaning time, is efficient, cleans and sanitizes completely. This a labor saving devise. Throughout the pastry and donut industry this cleaning unit is a must Anyone can clean with it Absolutely no maintenance, no bulky unit to store. A simple illustration explains how to use this unit. This Hopper Cleaning Unit is ready for a patent

1. The Unique Hopper Cleaning Unit can be used by the Donut/Pastry industry as a unit to clean hoppers that hold and dispense the fillings for donuts and pastries.
a. The unit is specifically useful in cleaning the hopper gears, eliminating the need to dissemble the hopper to clean the gears, drastically reducing chance of damage.
b. Using the Unique Hopper Cleaning Unit reduces hopper cleaning time from an hour to minutes.
c. This unit allows for the hoppers to be thoroughly cleaned on a daily basis.
